(19) United States
(12) Patent Application Publication
(10) Pub. No.: US 2012/0056810 A1
(43) Pub. Date: Mar. 8, 2012

(54) DATA INPUT DEVICE AND SOUND GENERATING DEVICE

(75) Inventors: David John Skulina, Edinburgh (GB); Benjaman Warren Schogler, Edinburgh (GB)

(73) Assignee: THE UNIVERSITY COURT OF THE UNIVERSITY OF EDINBURGH, Edinburgh (GB)

(21) Appl. No.: 13/147,613

(22) PCT Filed: Feb. 4, 2010
(86) PCT No.: PCT/GB10/00205

§ 371 Date: Nov. 15, 2011

(30) Foreign Application Priority Data
Feb. 5, 2009 (GB) 0901858.1

(51) Int. Cl. G06F 3/033; G06F 3/01

(52) U.S. Cl. 345/161; 345/156

(57) ABSTRACT

Disclosed is a data input device for providing a plurality of input signals responsive to user actions, comprising a resilient body and one or more sensors within the resilient body, which typically has a shape defining one or more modes of deformation, operable to provide the input signals responsive to deformation of the resilient body, by the actions of a user by virtue of the forces transmitted through the resilient body to the one or more sensors. By providing a deformable resilient body, typically defining one or more modes of deformation, only a subset of the plurality of input signals respond significantly to the deformation (typically to degree of deformation), a user lacking fine motor skills is able to better control a plurality of input signals.

### FIELD OF THE INVENTION

The present invention relates to the field of data input devices and sound generating devices including data input devices.

### BACKGROUND TO THE INVENTION

Issues concerning data input devices according to the present invention will now be discussed with reference to the application of providing sound generating devices which respond to user actions. However, data input devices according to the invention are applicable to a range of other applications where it is necessary to simultaneously provide multiple input signals, each input signal having a value from a range of possible values.

Commercially available data input devices for computers or other electronic devices are typically designed to function according to the requirements of an average human user conducting common data input tasks. Therefore, the great majority commercially available data input devices are adapted for use by individuals having normal levels of motor control, cognitive ability and/or sensory perception. Consequently, such devices may be unsatisfactory for use by persons with levels of sensory impairment, or whose cognitive abilities fall outside of the normal ranges found in the adult population.

For example, particularly young children, or special needs children and adults may have lower levels of motor control than an average adult. Consequently, data input devices typically function with greater sensitivity and resolution than such individuals are able to exert. Indeed, the fundamental size and shape of conventional user interface devices (such as computer mice, keyboards, touch screens, tracker balls and the like) may be unsuitable for use by persons with sensory or cognitive impairments.

For example, it is well known in the fields of special needs education and therapy that music and/or light provides a powerful means of interacting with, stimulating and teaching children and adults. Most electronic or conventional musical instruments are far too complex to operate to provide a satisfactory experience for special needs children and adults. Although a number of computer software packages provide simplified interfaces with which to interact (which might provide interactive musical and/or visual responses to data input), the use of these interfaces necessarily requires the use of one or more conventional data input devices, and these devices are optimised for use by normal adults. Consequently, the utility and effectiveness of the software packages and teaching or therapy strategies may be compromised by the data input device.

Data input devices are, in addition, not typically designed for use by persons having particular sensory impairments, such as blindness or deafness, or a combination of sensory impairments. The balance of sensory feedback from and sensory input to data input devices required by these individuals may differ substantially from those of the normal adult population. For example, a visually impaired person will be unable or less able to perceive visual feedback from data input devices (such as portions of a device which light up), whereas they might benefit greatly from additional textural feedback (for example surface finish, variety of materials used) than are available from conventional user interface devices.

Thus, there remains a need for user interface devices adapted for use by individuals having impaired motor control, cognitive ability, or one or more sensory impairments.

### SUMMARY OF THE INVENTION

According to a first aspect of the present invention there is provided a data input device for providing a plurality of input signals responsive to user actions, each said input signal having a value from a range of possible values, the data input device comprising a resilient body and one or more sensors within the resilient body, which one or more sensors are operable to provide the input signals responsive to deformation of the resilient body by the actions of a user by virtue of the forces transmitted through the resilient body to the one or more sensors.

The resilient body preferably has a shape selected to define a plurality of modes of deformation to which at least one of the input signals is responsive. For example, the resilient body may have a shape selected to define a plurality of modes of deformation including one or more of; compression of one or more faces or structures, twisting of one or more faces or structures, and tilting of one or more faces or structures. Preferably, the at least one of the input signals are responsive to the degree of deformation of the resilient body according to one or more of the plurality of modes of deformation.

Preferably, the resilient body has a shape selected to define one or more modes of deformation which are selected such that, when the shape is deformed according to a respective mode of deformation, only a subset of the said plurality of input signals respond significantly to the deformation (typically to the degree of deformation). Preferably, when the shape is deformed according to one or more of the modes of deformation, at most half of the said plurality of input signals change responsive to the deformation (typically to the degree of deformation). Preferably, the said plurality of input signals comprises at least six input signals and, when the shape is deformed according to any one of a plurality of said modes of deformation, at most three of the input signals vary significantly with deformation (typically with the degree of deformation).

Although sensitive sensors providing multiple outputs with multiple independent degrees of freedom are available and are useful for enabling a user to control a plurality of input signals (for example, three-dimensional joysticks), the relatively large number of degrees of freedom can make some such devices difficult to control carefully. For example, fine motor skills are required to vary only one output of a three-dimensional joystick providing six degrees of freedom. Whereas, by providing a resilient body defining one or more modes of deformation selected such that when the shape is deformed according to one of the respective modes of deformation, only a subset of the plurality of input signals respond significantly to the deformation (typically to degree of deformation), a user lacking fine motor skills is able to better control a plurality of input signals.

The resilient body may have a shape selected to define more modes of deformation to which at least one of the input signals are responsive than the number of independent degrees of freedom of the one or more sensors. The resilient body may have a shape selected to define fewer, or the same number of, modes of deformation to which at least one of the input sensors are responsive, than the number of independent degrees of freedom of the one or more sensors.

The resilient body may be adapted to provide a user with a plurality of affordances to which at least one of the input signals are responsive. The plurality of affordances may be greater than the number of independent degrees of freedom of the one or more sensors. In some embodiments, the plurality of affordances is less than, or equal to, the number of independent degrees of freedom of the one or more sensors.

The resilient body is preferably generally in the form of a convex polyhedron having a plurality of faces. For example, the resilient body may be generally in the form of a cube, cuboid, tetrahedron, hexahedron or octahedron.

A data input device having a resilient body is operable to provide to a user a direct and perceivable relationship between deformation and input signal. For example, the input signal may be input to a device for generating sound such, such that the user is provided with a direct and perceivable relationship between deformation and the sound.

One or more of the said plurality of faces may comprise a protrusion. The protrusion may be rounded. By providing a protrusion from a face of a polygonal resilient body, the possibility of pressing the protrusion, and thereby deforming the resilient body, is suggested to a user. The or each said protrusion preferably meets the face from which it protrudes at an acute angle, which is preferably less than 75° and more preferably less than 60°. For example, the or each protrusion may be generally in the form of a hemisphere. The or each protrusion may be generally in the form of a spherical cap (by spherical cap we mean the region of a sphere which lies above (or below) a given plane) which meets the face from which it protrudes at an angle of less than 75° or, preferably, less than 60°. This configuration communicates to a user the possibility of pressing the protrusion.

In alternative embodiments, the resilient body is a geometric shape, such as a sphere, spheroid, or a cylinder and may be provided with a structure, such as a protrusion, or a plurality of structures positioned to suggest the possibility of pressing, or otherwise deforming, the or each protrusion or structure to a user.

The or each protrusion, or structure, may have the same, or a different elastic modulus to the resilient body or to each other. The or each protrusion may be formed from the same, or a different material to the resilient body or to each other and may, for example have a different surface texture to the resilient body, or to each other.

In order to provide input signals by virtue of forces transmitted through the resilient body, some or all of the one or more sensors may be sensitive to motion. By sensitive to motion we include force sensors and strain gauges having a part which moves in use in response to an applied force, even if only on a microscopic scale. For example, some or all of the one or more sensors may comprises a reference member and a force receiving member for receiving forces transmitted through the resilient body, and provide the one or more input signals responsive to movement of the force receiving member relative to the reference member. One or more said sensors may provide input signals responsive to twisting, tilting, or lateral displacement of the force receiving member relative to the reference member. The reference member may, for example, be a sensor body. However, it may be that the reference member and force receiving member are equivalent to each other.

The resilient body may comprise a sensor supporting member, for example a base, which has a higher elastic modulus than the resilient body. The body of the sensor may be mounted to the sensor supporting member. The sensor supporting member may, for example, be substantially rigid, or may be resilient, but with a substantially higher elastic modulus than the resilient body. By providing a sensor supporting member with a higher elastic modulus than the resilient body a relatively stable portion is provided, facilitating the measurement of relative movements. The sensor supporting member may be adapted for fixing to an object, such as an item of furniture, wall, the ground etc. The invention extends to an item of furniture, such as a chair or table, having the data input device fixed thereto.

Preferably, the resilient body is formed and arranged such that, in respect of one or more modes of deformation of the resilient body to which one or more of the input signals is responsive, the movement of the resilient body is greater than, or preferably at least three times, or more preferably at least ten times, or more preferably at least one hundred, times the corresponding movement in a force receiving member of one or more sensors which provide the input signals responsive to the respective deformation. Thus, compact sensors can be employed while providing a data input device which is responsive to relatively large deformations. This is especially helpful when providing data input devices for use by children and individuals with special needs.

The one or more sensors may comprise or consist of a sensor having a reference member and a force receiving member, which sensor provides a plurality of signals which respond to movement of the force receiving member, relative to the reference member, in at least two, and typically three, independent axes. For example, the sensor may provide a plurality of signals which are indicative of the displacement of the force receiving member relative to the base in each of three orthogonal axes.

The one or more sensors may comprise or consist of a sensor having a reference member and a force receiving member, which sensor provides a plurality of signals which respond (typically independently) to rotation of the force receiving member, relative to the reference member, in at least two, and typically three, independent axes. For example, the sensor may provide a plurality of signals which are indicative of the rotation of the force receiving member around the normal of the force receiving member and the rotation of the force receiving member relative to the base around two different, typically orthogonal, axes.

The one or more sensors may comprise or consist of a joystick having at least five, and typically at least six independent degrees of freedom.

The resilient body may be in continuous contact with at least the force receiving member of the sensor. Thus, any even small deformations of the resilient body may result in forces being transmitted to the force receiving member of the sensor. The data input device may be adapted to calibrate one or more of the input signals to compensate for offset due to any forces being transmitted to the force receiving member of the sensor when the resilient body is not deformed.

However, it may be that a space is provided between some or all of the force receiving member of the sensor and the resilient body. The space may, for example, be an air space or a vacuum. This has the benefit of reducing or removing forces acting on the force receiving member of the sensor when the resilient body is not deformed.

Preferably, the volume of the resilient body is greater than ten times the volume of the one or more sensors. Thus, relatively large movements by a user can be measured using compact sensors.

The input signals are typically digital signals. Typically the data input device converts analogue user actions into digital input signals and thereby functions as an analogue to digital converter. In some embodiments, the input signals are analogue signals. For example, some data input devices are analogue devices and provide analogue input signals which, in use (for example when the input signals are received by a computer), are converted into digital signals (for example by a computer comprising an analogue to digital converter).

Typically each input signal is a digital signal having a bit depth of at least four and preferably at least eight. The range of possible values is typically a continuous numerical range. Some or all of the input signals preferably respond proportionately to a corresponding relative movement (e.g. relative displacement or relative rotation) of a force receiving member and a reference member of a sensor.

The data input device may further provide one or more input signals responsive to translation, rotation, acceleration or angular acceleration of the data input device.

The data input device may have a major dimension of between 5 and 50 cm, preferably between 10 and 30 cm. We have found that data input devices within this size range are especially useful as musical instruments and/or to provide input to physical model simulations of one or more musical instruments as they are of suitable dimension to be manually operated.

The resilient body may comprise one or more recesses for receiving a user's hand, limb or entire body. In some embodiments, the resilient body may comprise an internal chamber for receiving a user's hand, limb or entire body. In this case, a plurality of said sensors is typically provided within the resilient body around the internal chamber.

The data input device may comprise an interface, which may be wired or wireless, for outputting the input signals to a computing device.

According to a second aspect of the present invention there is provided a data input device for providing a plurality of input signals responsive to user actions, each said input signal having a value from a range of possible values, the data input device comprising a resilient body formed and arranged to define a plurality of modes of deformation, wherein the one or more input signals are responsive to deformation of the resilient body.

Optional and preferred features of the second aspect of the invention correspond to those discussed above in relation to the first aspect.

The invention extends in a third aspect to sound generating apparatus comprising a data input device according to the first or second aspect of the invention, wherein the sound generated by the sound generating apparatus is responsive to the said plurality of input signals.

Preferably, the sound generating apparatus comprises a physical modelling synthesis module which outputs sound dependent on a physical model of one or more instruments, wherein some or all of the said plurality of input signals are provided as inputs to the physical model synthesis. The physical modelling synthesis model may implement a plurality of physical models, for example physical models of different instruments. Some or all of the input signals may be applied as inputs to the same physical model. Different input signals may be applied as inputs to different physical models. For, example, input signals relating to displacement of a sensor force receiving member relative to a reference member parallel to two or three (typically orthogonal) axes may be applied to two or three respectively different physical models. Some or all of the input signals may be applied as inputs to a plurality of different physical models. For example, an input signal relating to the rotation of a sensor force receiving member relative to a reference member, around an axis may be applied as input to a plurality of different physical models, for example, two or three of the said different physical models.

The sound generating apparatus may comprise data processing means, such as one or more microprocessors or microcontrollers. The data processing means may be a computer in electronic communication with the data input device. The data processing means, and sounding means, such as a loudspeaker, may be integral to the data input device. Accordingly, the data input device may comprise sound generating apparatus. Thus, the sound generating apparatus and, in some embodiments the data input device, may function as a musical instrument.

According to a fourth aspect, the invention provides computer program code which, when executed on a computing device, is operable to process input signals received from a data input device according to the first or second aspect of the invention.

The computer program code may be operable to process said receive input signals to provide audio output, using some or all of the said input signals as inputs to a physical model synthesis of one or more musical instruments.

The invention further extends to a computer readable medium storing computer program code according to the fourth aspect of the invention.

### DESCRIPTION OF THE DRAWINGS

An example embodiment of the present invention will now be illustrated with reference to the following Figures in which:

FIG. 1 is a part cut-away side view of a data input device;

FIG. 2 is a cross-sectional view of a data input device;

FIG. 3 is an exploded cross-sectional view of the data input device of FIG. 1;

FIG. 4 is a side view of a data input device, illustrating modes of deformation; and

FIG. 5 is a schematic diagram of sound generating apparatus including the data input device.

### DETAILED DESCRIPTION OF AN EXAMPLE EMBODIMENT

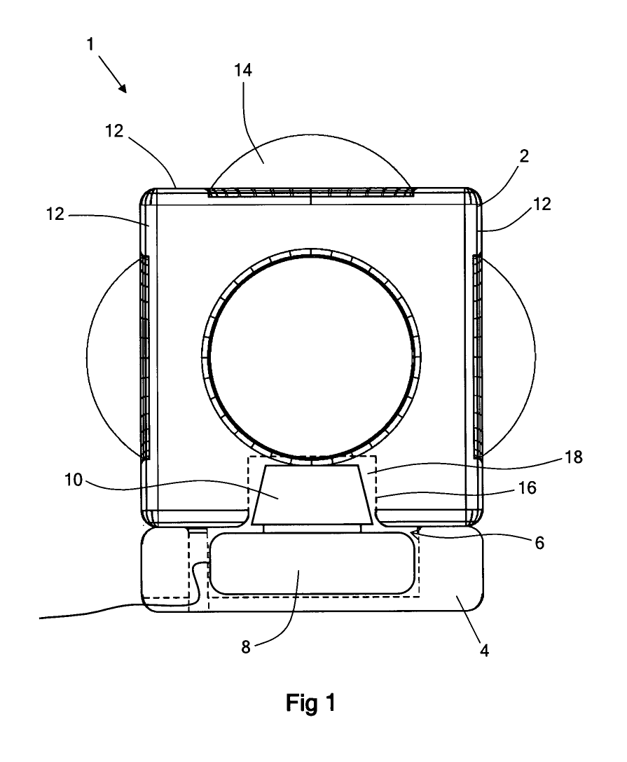

With reference to FIGS. 1 to 4, a data input device 1 comprises a resilient body 2, generally in the shape of a cube, and a base 4. Within the resilient body, there is provided a sensor in the form of a 3-D joystick 6, comprising a sensor base 8 (functioning as the reference member), and a movable portion 10 (functioning as the force receiving member). The sensor base 8 is retained within the base 4 of the data input device.

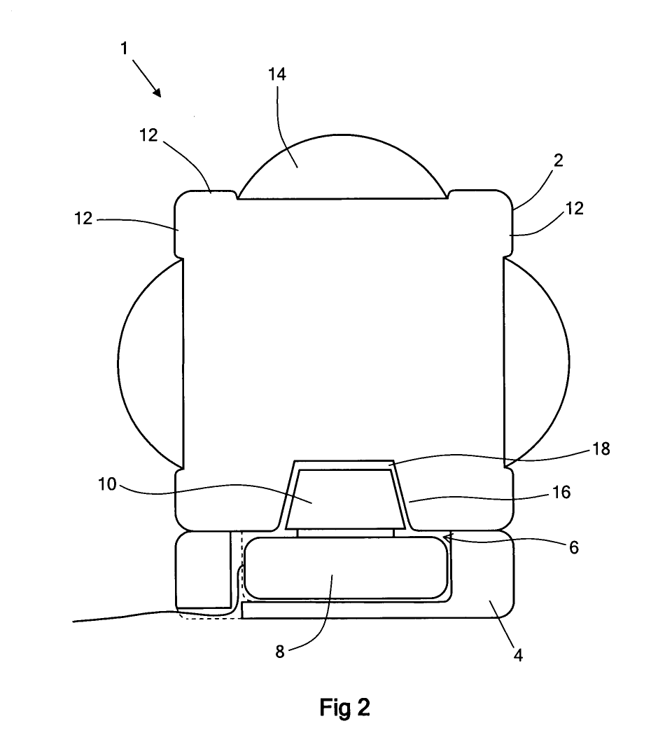

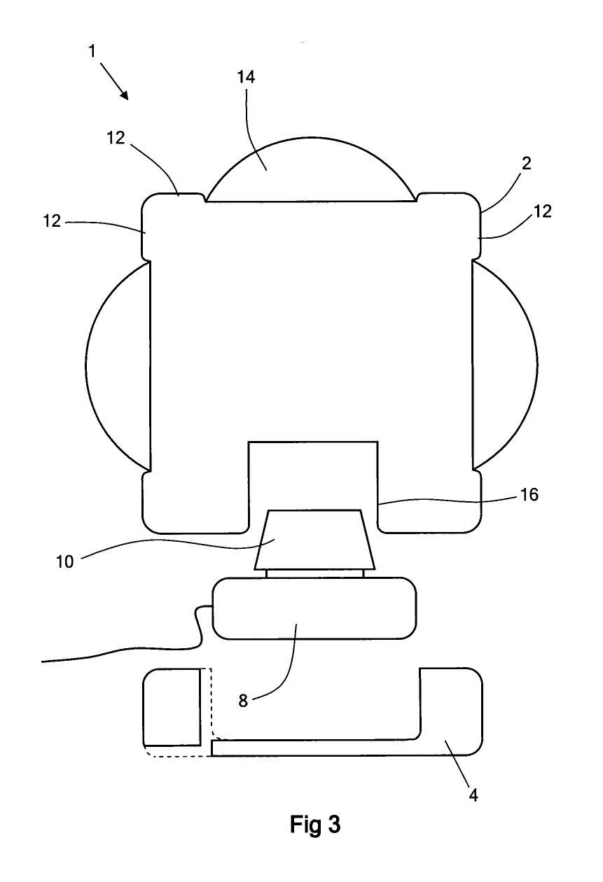

The external surfaces 12 of the resilient body are generally flat, with protrusions 14 extending therefrom. The protrusions are each in the form of a part-hemisphere, which meets with the generally flat external surfaces at an angle of around 45°. The interior of the resilient body includes a cutaway portion 16, which extends around the movable portion of the sensor, leaving a small gap, which may be for example 1 mm to 2 mm, around the of the sensor. The cutaway portion may be profiled such that the small gap is substantially constant at all points around the sensor, as shown in the embodiment of FIG. 2. Alternatively, for example in order to provide a resilient body suitable to receive more than one size or shape of sensor, the cutaway portion may be a simple cuboid, prismatic or cylindrical shape, as show in FIGS. 1 and 3.

The resilient body is made from polyurethane, and is formed as a single unitary block of material. However, the resilient body is formed from a multi-stage moulding procedure, and the protrusions, which are also formed from polyurethane, can be selected to have a greater elastic modulus, or a smaller elastic modulus, than the bulk of the resilient body. The outer surface of the resilient body is selected to be readily cleaned, and the protrusions are brightly coloured, for example the protrusions may each be a primary colour. In some embodiments, some or all of the protrusions are provided with a textured surface (such as a roughened surface or a fluffy surface).

Protrusions composed of a different material, having different surface textures and/or a different elastic modulus advantageously provide a user with additional tactile information. This may be particularly important for use by the visually impaired. One or more of the plurality of affordances may be encouraged or emphasised by the properties or texture of the protrusions. Similarly, the properties or texture of the protrusions may more clearly define one or more, or all, of the modes of deformation to a user.

In some embodiments, the protrusions are detachably secured to the resilient body. For example, detachably secured protrusions may be exchanged for protrusions of different shape, or colour or texture. Detachably secured protrusions enable the resilient body to be adapted for alternative uses. For example a plurality of different coloured protrusions might be replaced with protrusions having a plurality of surface textures, for use by people with impaired vision.

The 3-D joystick has six degrees of freedom. The moveable portion may be translated, relative to the base, in each of three orthogonal directions. Furthermore, the movable portion may be twisted around the central axis of the 3-D joystick, or rolled around either of two further axes, which are orthogonal to each other and the central axis. The 3-D joystick provides six output signals, each of which is a digital signal extending across an appropriate range, for example 0 to 255, which is proportional to the position of the movable portion, relative to the base, within his range of movement, according to each of the six degrees of freedom. The six signals are digitised and encoded onto two output channels. A suitable 3D-joystick is the SpaceNavigator 3D mouse available from 3Dconnexion. (SpaceNavigator is a Trade Mark of 3Dconnexion Holdings S.A.)

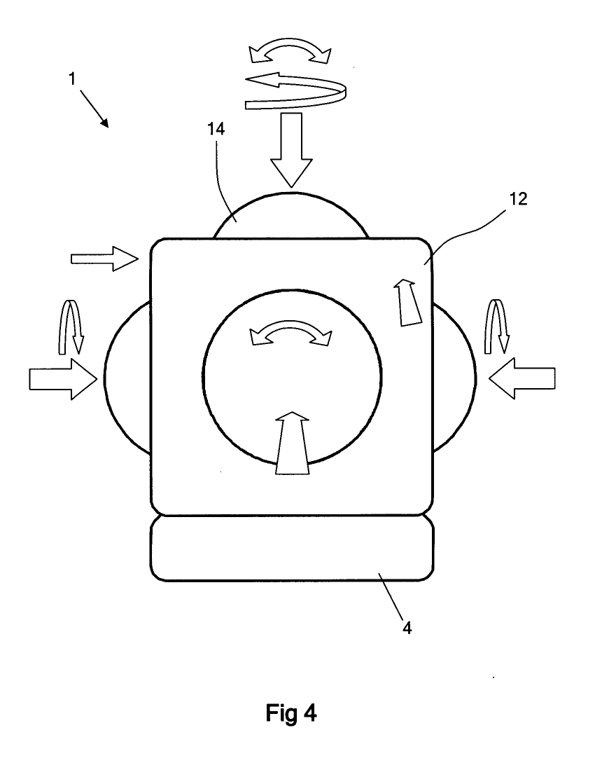

As illustrated in FIG. 4, the resilient body can be manually deformed according to a number of different modes of deformation. For example, each of the five outward facing services may be pressed inwards. Each of the five outward facing services may be rotated, in either direction. Each of the five outward facing services may be tilted. Furthermore, the device as a whole can be sheared. Due to the design of the resilient body, these modes of deformation are apparent to users, and function as affordances.

As the protrusions (shaped generally as spherical caps) meet the generally flat faces of the resilient body at an angle of around 45°, it is apparent to the user that the protrusions may be pushed, thereby pressing a respective outward facing surface of the resilient body inwards. If the protrusions were hemispheres, for example, which met the generally flat faces at an angle of around 90°, a user would instead be tempted to squeeze the protrusions, which would not transmit forces through the resilient body to the 3-D joystick. There would also be locations on the protrusions, near their circumferences, where they meet the respective generally flat face, whether could be pressed at an orientation which would not result in force is being transmitted through the resilient body to the 3-D joystick.

In use, a user manipulates the resilient body. When they do not apply any forces to the resilient body, and it adopts its natural undistorted configuration, no forces act on the 3-D joystick, by virtue of the space around the movable portion of the 3-D joystick. Similarly, very small distortions of the resilient body will not affect the outputs of the 3-D joystick. However, once the distortion is sufficient to cause the interior surface of the resilient body to contact the movable portion of the 3-D joystick, further distortion slightly displaces the movable portion of the 3-D joystick and, as a result, causes a change in one or more of the signals produced by the 3-D joystick. In an alternative embodiment, the 3-D joystick fits snugly within the cutaway portion of the resilient body. In this case, the 3-D joystick may be disturbed from its equilibrium position when the resilient body is in its undeformed state. However, the device driver software discussed below, or electronics embedded into the data input device can allow for this by suitable calibration.

Importantly, the resilient body effectively operates as an amplifier of movement with a gain of much less than 1, for example, less than 0.1 or less than 0.01. Relatively large movements in the surface of the resilient body, for example relatively large depressions of the protrusions, create relatively small corresponding movements of the movable portion of the 3-D joystick relative to the base of the 3-D joystick. This is important in the application, described below, of the data input device for controlling a music synthesiser, for use with children or individuals with special needs, to help them develop their motor skills and musical abilities.

Furthermore, some of the modes of deformation of the resilient body affect more than one of the signals produced by the 3-D joystick. Thus, the data input device provides many ways for users to express themselves.

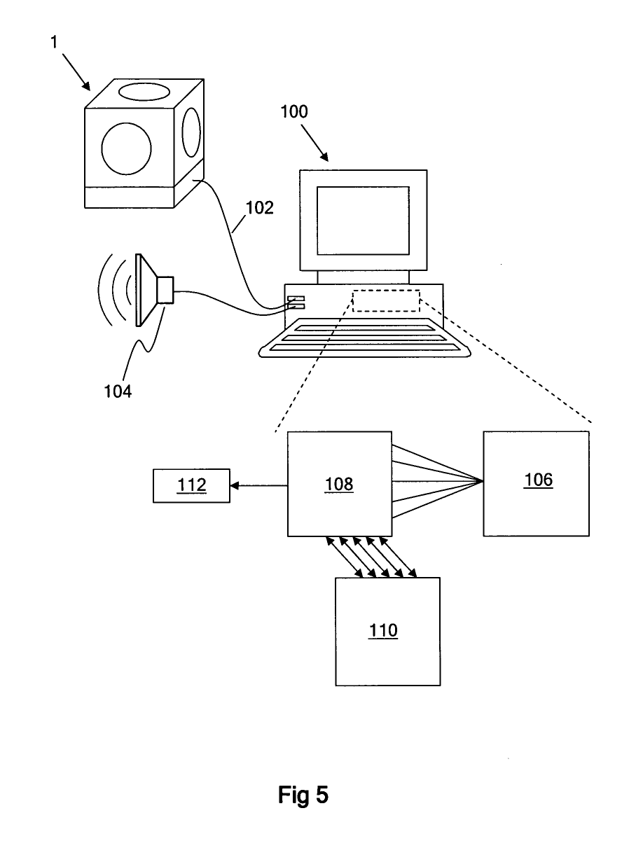

With reference to FIG. 5, one application of the data input device is for controlling a music synthesiser. In this example embodiment, the music synthesis is carried out by a computer 100, which receives, as inputs, the signals (which, for example, might comprise the six digitised signals encoded onto two output channels) output by the 3-D joystick of the data input device, by way of a wired connection 102, for example, a USB connector. Alternatively, the data input device that might include a wireless transmitter, or transceiver, for communicating the signals to the computer. The computer is properly connected to a loudspeaker 104, for outputting generated sound.

Signals are received from the data input device or process by a device driver software module 106, which processes the receives signals and outputs a plurality of independent signals 108 (for example the six digitised signals might be extracted from the two output channels), corresponding to the signals produced by the 3-D joystick, or driver. The signals are communicated to a software application 110, which controls the generation of music. The signals received from the device driver software are provided as independent inputs to physical models 112 of one or more instruments, and the software application uses the physical models to generate sound responsive to the deformations of the data input device by a user, in use. For example, the signals related to the displacement of the moveable portion parallel to each of three orthogonal axes may be applied to the inputs of different physical models, for example physical models concerning different instruments. Sounds generated according to each physical model can be combined. One or more of the three further rotation/tilt signals may each be input as parameters to more than one of the physical models.

Thus, a musical instrument can be provided in which the various manual manipulations of the resilient body by the user control and/or modify, the sounds which are generated. Thus, for example, pushing one protrusion inwards might affect the volume of the output sound. Pressing another protrusion might amend another input to the physical model of an instrument, for example, the simulated lip pressure on a wind instrument, or the bowing speed or bow pressure on the strings of a bow instrument. The base of the data input device is typically secured to a surface, for example, a table, although a hand-held version could be contemplated.

The musical instrument is especially useful with children, or individuals with special needs, as they are provided with various modes in which they can control, or influence, the sounds which are generated. They can make relatively large motions, using a convenient, tactile and visually attractive data input device. As the input signals are used as inputs to a physical model synthesis, it is easier for the user to generate a desired sound than with a conventional musical instrument. The resilient body provides a user with a tactile response to applied pressure, having a direct and perceivable relationship to the pressure that the user applies.

As a result of the resilient nature of the resilient body, the data input device is difficult to break. It may be provided in a waterproof form by sealing the connection between the resilient body and the base.

The resilient body may take any of the range of different forms. Typically, the resilient body is generally polygonal. Polygonal bodies provide a suitable range of modes of deformation, which are neither so few as to provide only a very limited range of affordances to a user, nor so large as to make the device difficult to control or use. Nevertheless, the resilient body may take another form, for example, it may be amorphous or generally spherical.

In some embodiments, music synthesis apparatus may be provided which has the data input device included therein. Thus, a device with the general appearance illustrated in FIGS. 1 to 5 may function as a standalone music synthesis device.

In some embodiments, recesses may be provided into which a user can insert their hand or a limb. In large-scale embodiments, a user may climb into a recess or space within the resilient body. Large-scale embodiments may respond to affordances such as users lying on, sitting on, or throwing themselves on or against the resilient body.

The data input device is also useful in other applications where it is desirable to generate several input signals simultaneously, which input signals have a value from a range (typically a continuous numeric range) of values.

Further variations and modifications may be made within the scope of the invention herein disclosed.

1. A data input device for providing a plurality of input signals responsive to user actions, each said input signal having a value from a range of possible values, the data input device comprising:
a resilient body;
one or more sensors within the resilient body;
wherein one or more sensors are operable to provide the input signals responsive to deformation of the resilient body by the actions of a user by virtue of the forces transmitted through the resilient body to the one or more sensors; and
wherein the one or more sensors comprises a sensor having a reference member and a force receiving member for receiving forces transmitted through the resilient body, which sensor is configured to provide a plurality of input signals which respond to rotation of the force receiving member relative to the reference member in at least two independent axes.

2. A data input device according to claim 1, wherein the resilient body has a shape selected to define a plurality of modes of deformation to which at least one of the input signals is responsive.

3. A data input device according to claim 2, wherein the at least one of the input signals are responsive to the degree of deformation of the resilient body according to one or more of the plurality of modes of deformation.

4. A data input device according to claim 2, wherein the resilient body has a shape selected to define one or more modes of deformation which are selected such that, when the shape is deformed according to a respective mode of deformation, only a subset of the said plurality of input signals respond significantly to the deformation.

5. A data input device according to claim 1, wherein the resilient body is generally in the form of a convex polyhedron having a plurality of faces.

6. A data input device according to claim 5, wherein one or more of the said plurality of faces comprises a protrusion.

7. A data input device according to claim 6, wherein the or each said protrusion meets the face from which it protrudes at an acute angle.

8. A data input device according to claim 1, wherein some or all of the one or more sensors are sensitive to motion.

9. A data input device according to claim 1, wherein the resilient body comprises a sensor supporting member which has a higher elastic modulus than the resilient body.

10. A data input device according to claim 1, wherein the resilient body is formed and arranged such that, in respect of one or more modes of deformation of the resilient body to which one or more of the input signals is responsive, the movement of the resilient body is greater than the corresponding movement in a force receiving member of one or more sensors which provide the input signals responsive to the respective deformation.

11. A data input device according to claim 1, wherein the one or more sensors comprise or consist of a sensor having a reference member and a force receiving member, which sensor provides a plurality of signals which respond to movement of the force receiving member, relative to the reference member, in at least two independent axes.

12. A data input device according to claim 1, wherein the one or more sensors comprise or consist of a joystick having at least five independent degrees of freedom.

13. A data input device according to claim 1, wherein a space is provided between some or all of the force receiving member of the sensor and the resilient body.

14. A data input device according to claim 1, wherein the volume of the resilient body is greater than ten times the volume of the one or more sensors.

15. A data input device according to claim 1, wherein the input signals are digital signals having a bit depth of at least four.

16. A data input device according to claim 1, having a major dimension of between 5 and 50 cm.

17. A data input device according to claim 1, wherein the resilient body comprises one or more recesses for receiving a user's hand, limb or entire body.

18. An item of furniture having a data input device according to claim 1 fixed thereto.

19. (canceled)

20. Sound generating apparatus comprising a data input device according to claim 1, wherein the sound generated by the sound generating apparatus is responsive to the said plurality of input signals.

21. Sound generating apparatus according to claim 20, wherein the sound generating apparatus comprises a physical modelling synthesis module which outputs sound dependent on a physical model of one or more instruments, wherein some or all of the said plurality of input signals are provided as inputs to the physical model synthesis.

22. Sound generating apparatus according to claim 21, wherein the physical modelling synthesis module implements a plurality of physical models and different input signals are applied as inputs to different physical models.

23. Sound generating apparatus according to claim 21 operable to function as a musical instrument.

24. Computer program code which, when executed on a computing device, is operable to process input signals received from a data input device according to claim 1.

25. A computer readable medium storing computer program code according to claim 24.
